(19) United States
(12) Patent Application Publication
(10) Pub. No.: US 2024/0173729 A1
(43) Pub. Date: May 30, 2024

(54) COATING DEVICE, IN PARTICULAR ROTARY ATOMIZER

(71) Applicant: Dürr Systems AG, Bietigheim-Bissingen (DE)

(72) Inventors: Siegfried Poppe, Unterriexingen (DE); Johannes Höchsmann, Asperg (DE); Martin Keilbach, Oberkessach (DE); Rainer Melcher, Oberstenfeld (DE)

(21) Appl. No.: 18/261,496

(22) PCT Filed: Jan. 17, 2022
(86) PCT No.: PCT/EP2022/050839

§ 371 Date: Jul. 14, 2023

(30) Foreign Application Priority Data
Jan. 19, 2021 (DE) 10 2021 101 028.4

(51) Int. Cl. B05B 5/04; B05B 13/04; G01P 3/481; G01P 3/487; G01P 13/04

(52) U.S. Cl. CPC B05B 5/0422; B05B 5/0407; B05B 13/0431; G01P 3/4815; G01P 3/487; G01P 13/045

(57) ABSTRACT

The disclosure relates to a coating device, in particular a rotary atomizer, for coating components, in particular motor vehicle body components, with an electrostatic coating agent charging system, so that the coating device comprises a high-voltage area and an electrically grounded area. Furthermore, the coating device comprises a sensor in the high-voltage area, in particular as a rotational speed sensor for measuring the rotational speed of the rotary atomizer, and an optical waveguide for transmitting a measurement signal of the sensor from the high-voltage area to the electrically grounded area, wherein the optical waveguide enables a potential separation between the high-voltage area and the electrically grounded area. The disclosure provides that the sensor is a magnetic sensor.

### CROSS-REFERENCE TO RELATED APPLICATIONS

This application is a national stage of, and claims priority to, Patent Cooperation Treaty Application No. PCT/EP2022/050839, filed on Jan. 17, 2022, which application claims priority to German Application No. DE 10 2021 101 028.4, filed on Jan. 19, 2021, which applications are hereby incorporated herein by reference in their entireties.

### FIELD

The disclosure relates to a coating device for coating components, in particular with a rotary atomizer for painting motor vehicle body components.

### BACKGROUND

In modern painting systems for painting motor vehicle body components, rotary atomizers are usually used as application device, which rotate a bell cup at high speed during painting operation, whereby the bell cup spins off the paint to be applied and thereby atomizes it.

Electrostatic coating agent charging is generally used here to increase the application efficiency (i.e. the ratio of the paint deposited on the motor vehicle body components to be painted to the total amount of paint applied) and to reduce the disturbing overspray accordingly. For this purpose, the motor vehicle body components to be painted are electrically grounded while the rotary atomizer is charged to a high-voltage potential so that the applied paint is also electrostatically charged accordingly. This leads to electrostatic attraction between the applied paint and the electrically grounded vehicle body components, so that the paint is deposited almost completely on the vehicle body components to be painted and only a small amount of overspray is produced. The painting systems therefore have a high-voltage area and an electrically grounded area, with the high-voltage area containing the rotary atomizer.

The rotary atomizers are usually driven by turbines powered by compressed air. From EP 1389 488 A2 it is further known to monitor the rotational speed of a rotary atomizer. For this purpose, the rear side of the turbine wheel is provided as a reflector disk with circular segment-shaped reflectors, which are detected by an optical sensor (e.g. photocell). The output signal of the optical sensor is then transmitted via an optical waveguide from the high-voltage area to the electrically grounded area, where the optical waveguide provides potential isolation.

One disadvantage of this known technical solution for monitoring the speed of a rotary atomizer is that the optical components (reflector disk, interfaces for incoming optical waveguide, etc.) are susceptible to contamination.

Another disadvantage of this known technical solution is the relatively high cost of the reflector and the optical sensor.

Finally, there is also the risk of electrocorrosion occurring on the reflector disk.

### BRIEF DESCRIPTION OF THE DRAWINGS

FIG. 1 shows a schematic representation of a painting system according to the invention with a rotary atomizer and a magnetic sensor for speed monitoring.

FIG. 2 shows a schematic representation to explain the principle of speed monitoring by means of a magnetic sensor according to the invention.

FIG. 3 shows a variation of FIG. 2 with two electro-optical transducers.

FIG. 4 shows a variation of FIG. 2 with an additional rectifier.

FIG. 5 shows a variation of FIG. 1 to illustrate the energy supply by the magnetic sensor.

FIG. 6 shows a cross-sectional view through a rotary atomizer according to the invention with a rotating magnetic sleeve.

FIG. 7 shows a perspective view of the magnetic sleeve from FIG. 6.

FIGS. 8A-8D show various illustrations to illustrate the speed detection by a magnetic sensor with a rotationally symmetrical magnetization.

FIGS. 9A-9D show variations of FIGS. 8A-8D with an asymmetric magnetization.

FIGS. 10A-10D show variations of FIGS. 8A-8D with an additional rectifier.

FIGS. 11A-11D show variations of FIGS. 9A-9D with an additional rectifier.

### DETAILED DESCRIPTION

In accordance with the prior art, the coating device according to the disclosure comprises an electrostatic coating agent charging system, as is known per se from the prior art and serves to electrostatically charge the applied coating agent. The coating device according to the disclosure therefore has a high-voltage area and an electrically grounded area.

The coating device according to the disclosure has a first sensor arranged in the high-voltage area. For example, the first sensor may be a rotational speed sensor used to detect the rotational speed of the rotary atomizer. However, the disclosure is not limited to speed sensors with respect to the type of the first sensor. Rather, within the scope of the disclosure, the first sensor can alternatively measure other operating variables of the coating device.

In accordance with the prior art, the coating device according to the disclosure also has an optical waveguide to transmit the measurement signal of the first sensor from the high-voltage area to the electrically grounded area, the optical waveguide also providing potential isolation between the high-voltage area and the electrically grounded area.

The disclosure differs from the prior art described at the beginning according to EP 1389 488 A2 in that the first sensor is a magnetic sensor, whereas in the prior art an optical sensor is used to scan the reflector disk. The use of a magnetic sensor instead of an optical sensor avoids the problems described above with regard to the susceptibility of the reflector disk to contamination and corrosion.

In general, it should also be mentioned that the coating device according to the disclosure is preferably a rotary atomizer. However, within the scope of the disclosure, it is alternatively also possible that the coating device comprises another type of atomizer, such as an air atomizer, an airless atomizer, or an ultrasonic atomizer, to name but a few examples.

Furthermore, it should also be mentioned in general that the coating device according to the disclosure is preferably a coating device which applies a paint as coating agent. However, it is also possible in principle within the scope of the disclosure for other types of coating agent to be applied alternatively.

Furthermore, it should be mentioned that the coating device according to the disclosure is preferably designed to coat motor vehicle body components. However, it is also possible in principle within the scope of the disclosure for other types of components to be coated alternatively.

The aforementioned magnetic sensor preferably generates an electrical signal, which is then converted into a corresponding optical signal by a first electro-optical transducer and coupled into the optical waveguide. In the preferred embodiment, the connection between the magnetic sensor and the electro-optical transducer is made by an electric line. In the technical realization of the disclosure in a rotary atomizer, the magnetic sensor, the electrical line and the electro-optical transducer are preferably arranged in the rotary atomizer, while the optical waveguide is located outside the rotary atomizer and establishes the connection to the electrically grounded area.

It has already been briefly mentioned above that the disclosure is preferably technically realized in a rotary atomizer which has a bell cup shaft which is rotatable about a rotation axis and serves to receive a bell cup, as is known per se from the prior art. The rotary atomizer is arranged in the high-voltage area and has a first magnetic element which rotates with the bell cup shaft of the rotary atomizer during operation and generates an alternating magnetic field during rotation. The first magnetic sensor is arranged stationary within the rotary atomizer and detects the alternating magnetic field generated by the rotating first magnetic element. With regard to the technical realization of the rotating magnetic element, there are various possibilities within the scope of the disclosure, which will be described in detail below.

In one variant of the disclosure, the rotary atomizer comprises a second magnetic element for detecting the direction of rotation, which also rotates with the bell cup shaft of the rotary atomizer during operation and thus generates an alternating magnetic field. The two magnetic elements are arranged in the circumferential direction with a certain angular offset, which is optionally not equal to 180°, in order to enable detection of the direction of rotation.

In addition, the rotation atomizer can have a second sensor for detecting the direction of rotation, in particular a second magnetic sensor. In this case, the two magnetic sensors are preferably arranged with a certain angular offset in the circumferential direction, the angular offset preferably not being equal to 180°, in order to enable detection of the direction of rotation.

In the above-described disclosure variant with two sensors, two electro-optical transducers can also be provided, which couple two signals into the optical waveguide, whereby the two signals can differ, for example, with regard to their wavelength, in order to be able to distinguish the two signals from one another at the receiver end.

The aforementioned electro-optical transducer for generating the optical signal can, for example, have a light-emitting diode, but other light sources are also possible in principle in order to couple a corresponding optical signal into the optical waveguide.

With regard to the structural design of the magnetic element, various possibilities exist within the scope of the disclosure, as already briefly mentioned above. For example, the magnet element can be designed as a ring magnet, which is then preferably aligned coaxially with the axis of rotation of the bell cup shaft.

Alternatively, it is possible for the magnetic element to be a bar magnet, which is then preferably aligned parallel to the axis of rotation of the bell cup shaft.

In a preferred embodiment of the disclosure, the magnetic element is a magnetic mass which is arranged in a sleeve, wherein the sleeve is preferably formed as a metal sleeve and can, for example, consist of VA steel (stainless steel).

When using a ring magnet in a rotary atomizer, the ring magnet is preferably aligned coaxially to the axis of rotation of the bell cup shaft and rotates together with the bell cup shaft. The ring magnet can have a multi-pole magnetization with several magnetic poles distributed around the circumference of the ring magnet. When the magnetic sensor is arranged on the rotating ring magnet, the magnetic sensor then generates a corresponding pulse with each pole change.

Here it is advantageous if the magnetization of the ring magnet is not rotationally symmetrical with respect to the axis of rotation of the bell cup, so that detection of the direction of rotation is also possible. If the magnetization of the ring magnet is rotationally symmetrical, the magnetic sensor generates a pulse train that is independent of the direction of rotation and therefore does not allow detection of the direction of rotation. Only magnetization that is not rotationally symmetrical with respect to the axis of rotation of the bell cup enables such detection of the direction of rotation.

With regard to the structural design of such a ring magnet, various possibilities exist within the scope of the disclosure. For example, the ring magnet can be divided into several segments which alternate in the circumferential direction. Furthermore, it is possible within the scope of the disclosure for the ring magnet to be molded using injection molding technology.

It has already been briefly mentioned above that the rotating magnetic element can be a magnetic mass which is arranged in a sleeve, the sleeve with the magnetic mass rotating together with the bell cup shaft. There is the possibility of integrating a further technical function in that the sleeve has a design-related speed stability and expands radially when a maximum speed is exceeded, thereby blocking the bell cup shaft. For this purpose, the sleeve can have one or more predetermined breaking points which break when the maximum speed is exceeded, causing the bell cup shaft to lock. The sleeve thus also limits the speed so that the speed of the bell cup shaft does not reach safety-critical values.

With regard to the operating principle of the magnetic sensor, it should be mentioned that a so-called Wiegand sensor is preferably used, whereby such sensors are also referred to as pulse wire sensors and are known per se from the prior art.

It has already been mentioned above that the magnetic sensor generates an electrical signal, which can then be converted into an optical signal and transmitted via the optical waveguide. However, the electrical signal generated by the magnetic sensor not only carries information about the direction of rotation and speed of rotation, but also contains electrical energy that can be used to supply power to electrical components. The coating device according to the disclosure (e.g. rotary atomizer) therefore preferably contains an electrical energy storage device (e.g. battery) which is charged by the magnetic sensor and supplies one or more electrical loads with the electrical energy required to operate the load.

For example, the load may be an electronic circuit (e.g., microcontroller) connected to the electro-optical transducer to transmit information to the electrically grounded area via the optical waveguide. For example, this information may relate to the operating time of the coating device or may include product identification data to identify the coating device. For example, the magnetization of the magnetic element may contain a code that not only enables recognition of the speed and direction of rotation, but also identifies the type of coating device or even identifies the coating device itself in terms of a serial number, thereby preventing product piracy.

In a preferred embodiment of the disclosure, the coating device is a rotary atomizer that includes a receiving tube extending between the turbine and the mounting flange of the rotary atomizer, the receiving tube including the magnetic sensor and the electro-optical transducer. In addition, the receiving tube may also contain other electronic components.

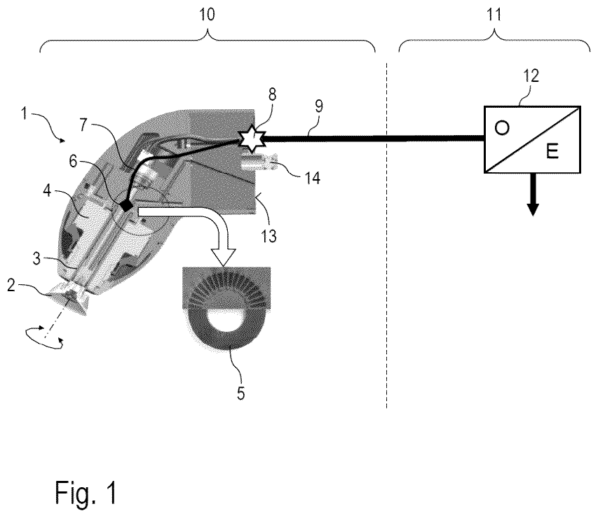

In the following, the embodiment example according to FIG. 1 will now be described, which has a rotary atomizer 1 as applicator, which is largely of conventional design. The rotary atomizer 1 is used to coat motor vehicle body components with a paint and for this purpose has a bell cup 2 which is screwed onto a bell cup shaft 3 and rotates at high speed about a rotation axis during operation. The bell cup shaft 3 is conventionally driven by a turbine 4 which is driven by compressed air.

The bell cup shaft 3 is connected to a ring magnet 5, whereby the ring magnet 5 is arranged coaxially to the bell cup shaft 3 and rotates with the bell cup shaft 3 during operation.

Next to the ring magnet 5 there is a magnetic sensor 6, shown only schematically, which detects the changing magnetic field generated by the rotating ring magnet 5 and thus enables speed monitoring.

In this embodiment, the magnetic sensor 6 is designed as a Wiegand sensor (pulse wire sensor), but other sensor types are also possible in principle.

The magnetic sensor 6 is connected via an electrical line 7 to an electro-optical transducer 8, which converts the output signal of the magnetic sensor 6 into an optical signal and couples it into an optical waveguide 9.

It should be mentioned here that the rotary atomizer 1 has components of a painting system with an electrostatic coating agent charge, so that the painting system has a high-voltage area 10 and an electrically grounded area 11. The rotary atomizer 1 is arranged in the high-voltage area 10 and is at high-voltage potential during painting operation. The optical waveguide 9 enables potential separation between the high-voltage area 10 and the electrically grounded area 11, which also contains an opto-electrical transducer 12.

Furthermore, it should be mentioned that the rotary atomizer 1 is moved in operation by a multi-axis painting robot, as is known per se from the prior art. For this purpose, the rotary atomizer 1 has a mounting flange 13 with a mounting pin 14 which can be attached to a corresponding mounting flange of the painting robot, as is known per se from DE 43 06 800 A1. The electro-optical transducer 8 is arranged here in the mounting flange 13.

The advantage of the above-described embodiment is the absence of a reflector disk, as used in the state of the art for optical speed detection. This avoids the problem of the reflector disk being susceptible to contamination and corrosion.

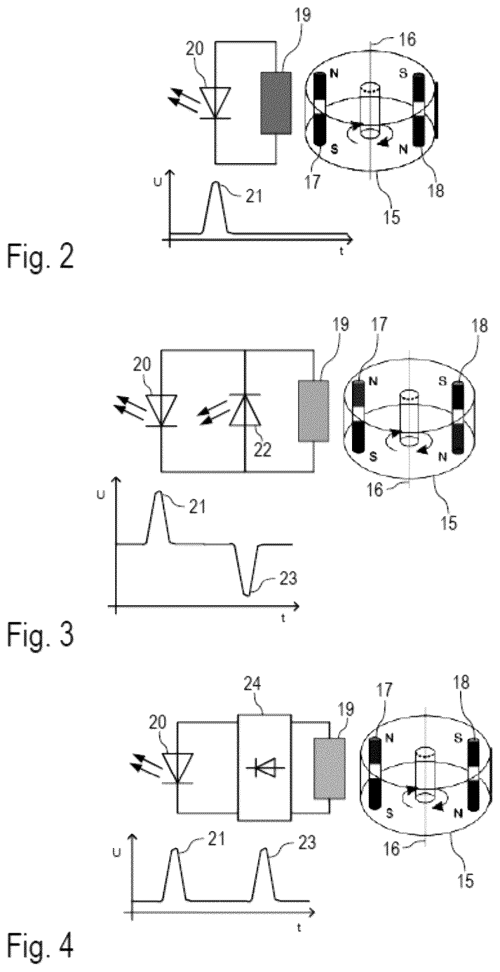

FIGS. 2-4 show various schematic diagrams illustrating the principle of speed monitoring by means of a magnetic sensor according to the disclosure. Here, a rotor 15 is generally shown which rotates about a rotation axis 16 during operation, whereby the rotor 15 can, for example, be connected to the bell cup shaft of a rotary atomizer and rotates with it. Two bar magnets 17, 18 are located in the rotor 15, which are arranged opposite each other and axially aligned.

Next to the rotor 15 is a magnetic sensor 19, which can be designed as a Wiegand sensor, for example, and which generates a corresponding electrical signal as a function of the magnetic field generated by the bar magnets 17, 18, which controls a light-emitting diode 20. The light-emitting diode 20 then emits a pulse 21 each time one of the bar magnets 17, 18 passes. It should be mentioned here that only one of the two bar magnets 17, 18 with the correct polarity generates a pulse 21 when passing the magnetic sensor 19, while the other bar magnet 17 or 18 does not generate a pulse 21 because of the incorrect polarity.

In the embodiment example according to FIG. 3, a further light-emitting diode 22 is provided in addition to the light-emitting diode 20, whereby the two light-emitting diodes 20, 22 are connected in parallel and have opposite polarity. This means that when each of the two bar magnets 17, 18 passes, a pulse 21 or 23 is emitted. This increases the measuring accuracy in speed detection, since more pulses 21, 23 are generated per angular unit.

In the example shown in FIG. 4, a rectifier 24 is arranged between the magnetic sensor 19 and the light-emitting diode 20, so that here, too, a pulse 21 or 23 is emitted when each of the two bar magnets 17, 18 passes.

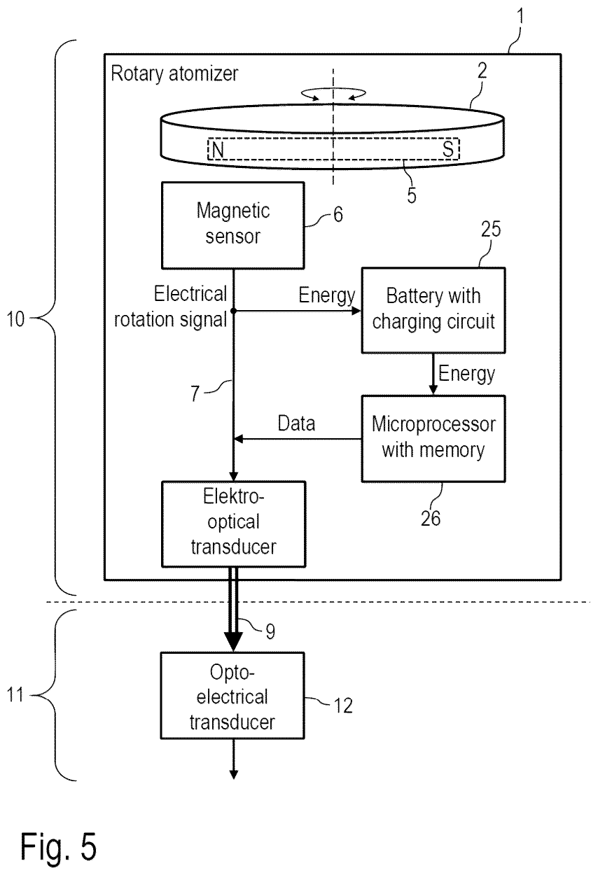

FIG. 5 shows a schematic representation which largely corresponds to FIG. 1, so that in order to avoid repetition, reference is made to the above description of FIG. 1, with corresponding details marked with the same reference signs.

In this illustration, it is additionally clarified how the output signal of the magnetic sensor 6 can also be used to supply power to electrical components in the rotary atomizer 1. Thus, a rechargeable battery 25 with a charging circuit is located in the rotary atomizer 1, whereby the battery 25 is supplied with power and charged by the output signal of the magnetic sensor 6.

The rechargeable battery 25 in turn feeds a microprocessor 26 with the electrical energy required for operation.

The microprocessor 26 is connected on the output side to the electro-optical transducer 8 and can thus transmit data via the optical waveguide 9 to the electrically grounded area 11. For example, this data may be product identification data that prevents product piracy.

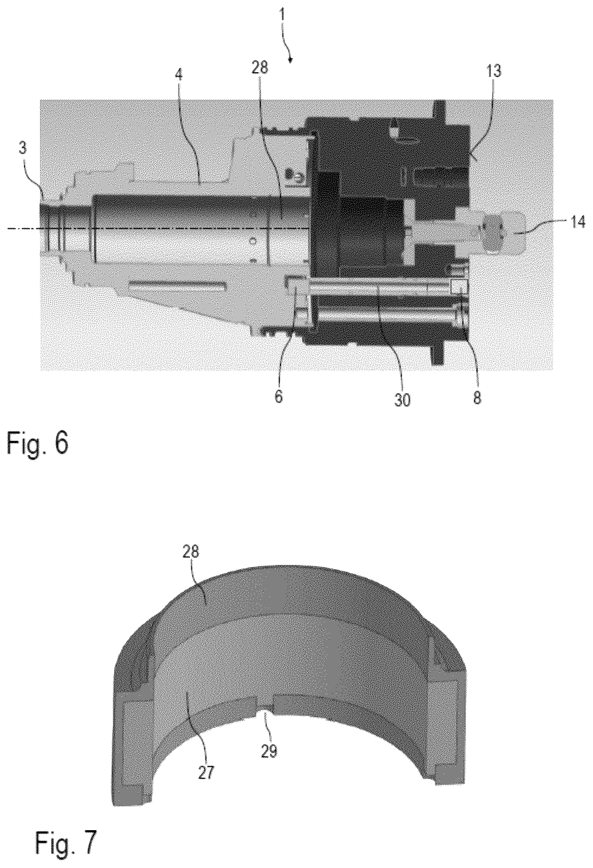

FIGS. 6 and 7 show a further modification of the embodiment example according to FIG. 1, so that to avoid repetition reference is again made to the above description for FIG. 1, the same reference signs being used for corresponding details.

A feature of this embodiment is that instead of the ring magnet shown in FIG. 1, a magnetic mass 27 is provided which is cast in a magnetic sleeve 28 made of VA steel. The magnetic mass 27 is magnetic and has several magnetic poles distributed in the circumferential direction, as will be described in detail. The magnetic sleeve 28 with the cast-in magnetic mass 27 rotates together with the bell cup shaft 3 during operation, so that the magnetic sleeve 28 generates a rotating magnetic field which is detected by the magnetic sensor 6.

However, the magnetic sleeve 28 with the magnetic mass 27 not only serves to detect the rotational speed and to control the magnetic sensor 6. Rather, the magnetic sleeve 28 also has a technical safety function. The magnetic sleeve 28 has predetermined breaking points 29 which break open when a certain speed is exceeded, so that the magnetic sleeve 28 then expands radially, which leads to blocking and thus to the rotary atomizer 1 being stuck. This causes a speed limitation, which prevents the speed of the rotary atomizer 1 from increasing into safety-critical ranges.

A further feature here is that the magnetic sensor 6 and the electro-optical transducer 8 are arranged together in a receiving tube 30 which extends in the rotary atomizer 1 from the mounting flange 13 to the turbine 4.

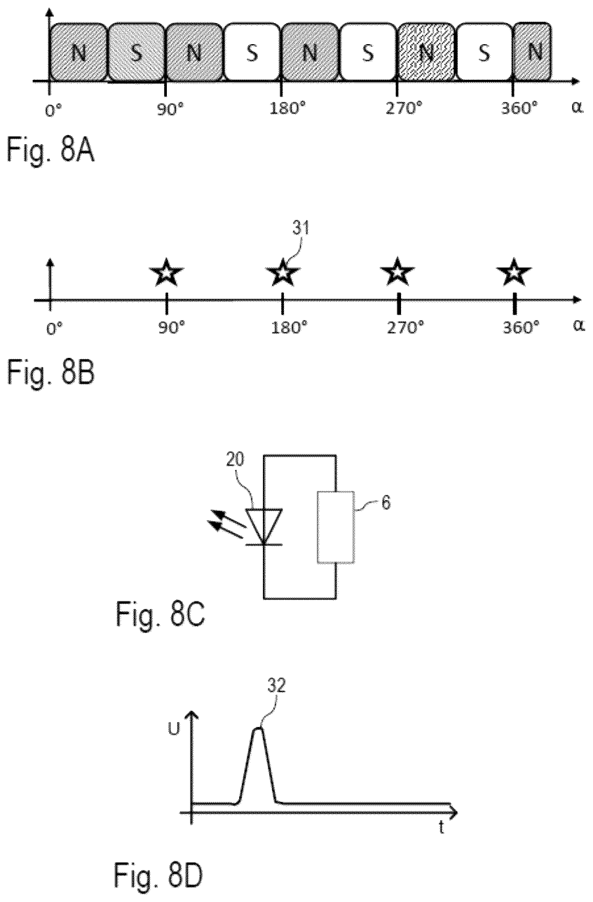

FIGS. 8A-8D serve to illustrate the principle of speed detection according to the disclosure by means of the magnetic sensor 6, which detects the magnetization of the ring magnet 5, as explained above.

FIG. 8A shows a rotationally symmetrical magnetization with equidistant distances between the individual magnetic poles N, S. As a result, the light-emitting diode 20 generates light pulses 31 which are equidistant. The light pulses 31 then generate corresponding voltage pulses 32 at the receiver end, which are also equidistant. This means that no detection of the direction of rotation is possible with the symmetrical magnetization shown.

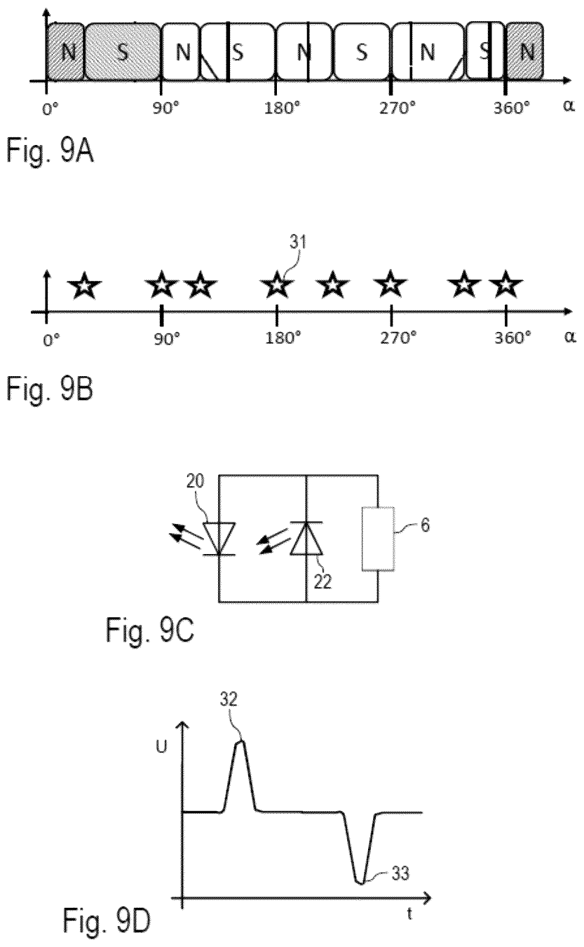

FIGS. 9A-9D therefore show a modification with a magnetization that is not symmetrical, as can be seen directly from FIG. 9A. Here, the generated light pulses 31 and the resulting voltage pulses 32, 33 are not equidistant, which makes rotation direction detection possible.

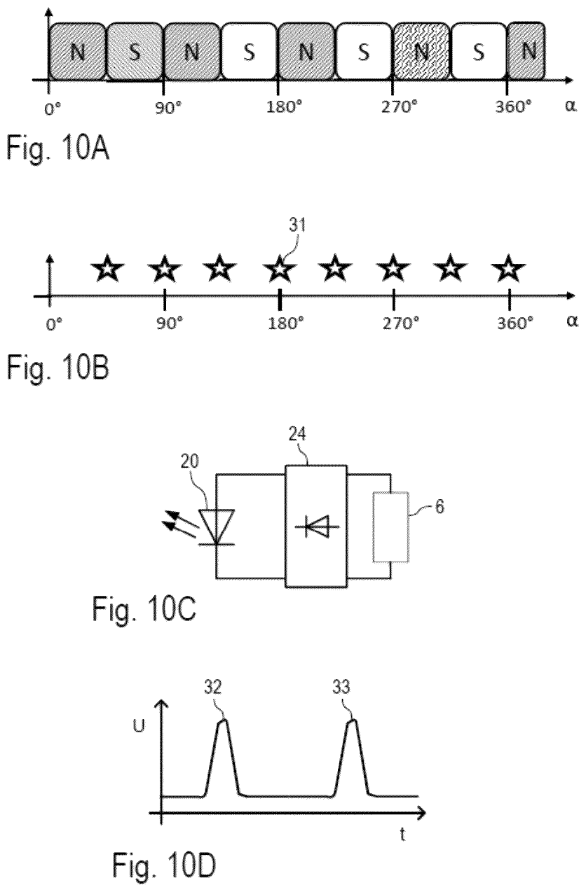

FIGS. 10A-10D show a variation of FIGS. 8A-8D with symmetrical magnetization, but with the additional rectifier 24 mentioned above.

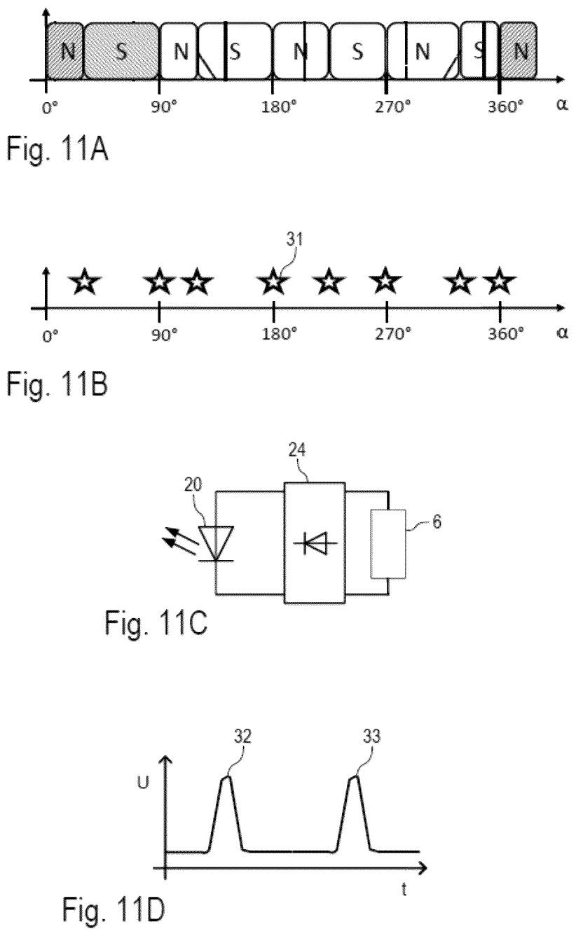

Finally, FIGS. 11A-11D show a variation of FIGS. 10A-10D with a non-symmetrical magnetization, which allows detection of the direction of rotation.

The disclosure is not limited to the preferred embodiments described above. Rather, the disclosure also encompasses variants and variations that make use of the inventive concept and bring it within the scope of protection. In particular, the disclosure also claims protection for the subject matter and the features of the dependent claims independently of the claims referenced in each case and, in particular, also without the features of the main claim. Thus, the disclosure comprises different aspects of the disclosure which enjoy protection independently of each other.

1.-16. (canceled)

17. A coating device for coating components, with
a) an electrostatic coating agent charging system, so that the coating device has a high-voltage area and an electrically grounded area,
b) a first sensor in the high-voltage area, and
c) an optical waveguide for transmitting a measurement signal of the first sensor from the high-voltage area to the electrically grounded area, the optical waveguide providing potential isolation between the high-voltage area and the electrically grounded area,
d) wherein the first sensor is a first magnetic sensor.

18. The coating device according to claim 17, further comprising a first electro-optical transducer which converts an electrical signal of the first sensor into a first optical signal and couples it into the optical waveguide.

19. The coating device according to claim 17, wherein
a) the coating device comprises a rotary atomizer with a bell cup shaft which can be rotated about a rotation axis and is used to hold a bell cup,
b) the rotary atomizer is arranged in the high-voltage area,
c) the rotary atomizer comprises a rotating first magnetic element which, in operation, rotates with the bell cup shaft of the rotary atomizer and generates an alternating magnetic field during rotation, and
d) the first magnetic sensor is arranged in a fixed position in the rotary atomizer and detects the alternating magnetic field generated by the rotating first magnetic element.

20. The coating device according to claim 19, wherein
a) for the purpose of detecting the direction of rotation, the rotary atomizer comprises a rotating second magnetic element which, during operation, rotates with the bell cup shaft of the rotary atomizer and generates an alternating magnetic field during rotation,
b) the rotating second magnetic element is arranged with a certain angular offset in the direction of rotation, offset from the rotating first magnetic element, in order to enable the detection of the direction of rotation,
c) the angular offset between the rotating first magnetic element and the rotating second magnetic element is not equal to 180°.

21. The coating device according to claim 19, wherein
a) the rotary atomizer comprises a second sensor for detecting the direction of rotation, and
b) the second sensor is arranged with a certain angular offset in the direction of rotation, offset from the rotating first sensor, in order to enable the detection of the direction of rotation.
c) the angular offset between the first sensor and the second sensor is not equal to 180°.

22. The coating device according to claim 21, wherein the second sensor is a second magnetic sensor.

23. The coating device according to claim 21, further comprising a second electro-optical transducer which converts an electrical signal of the second sensor into a second optical signal and couples it into the optical waveguide,

24. The coating device according to claim 23, wherein the two optical signals have different wavelengths in order to be able to transmit not only rotational speed information but also rotational direction information.

25. The coating device according to claim 23, wherein at least one of the first electro-optical transducer and the second electro-optical transducer comprises at least one light-emitting diode for generating the optical signal.

26. The coating device according to claim 20, wherein at least one of the rotating first magnetic element and the rotating second magnetic element comprises a design selected from a group consisting of:
a) a ring magnet,
b) a bar magnet, and
c) a magnetic mass in a sleeve.

27. The coating device according to claim 26, wherein the sleeve is a metal sleeve.

28. The coating device according to claim 26, wherein
a) the coating device comprises a rotary atomizer with a bell cup shaft which can be rotated about a rotation axis and is used to hold a bell cup,
b) the rotary atomizer is arranged in the high-voltage area,
c) the ring magnet comprises a multipole magnetization with a plurality of magnetic poles distributed in the circumferential direction.

29. The coating device according to claim 28, wherein the magnetization of the ring magnet is not rotationally symmetrical with respect to the axis of rotation of the bell cup shaft in order to enable detection of the direction of rotation.

30. The coating device according to claim 26, wherein the ring magnet is divided into several segments.

31. The coating device according to claim 26, wherein the ring magnet is injection molded.

32. The coating device according to claim 26, wherein
a) the coating device comprises a rotary atomizer with a bell cup shaft which is rotatable about a rotation axis and serves to receive a bell cup,
b) the rotary atomizer is arranged in the high-voltage area,
c) the sleeve with the magnetic mass rotates together with the bell cup shaft,
d) the sleeve comprises a design-related speed stability and expands radially when a maximum speed is exceeded, thereby blocking the bell cup shaft,
e) the sleeve comprises at least one predetermined breaking point which breaks when the maximum speed is exceeded, as a result of which the bell cup shaft locks.

33. The coating device according to claim 17, wherein at least one of the first magnetic sensor and the second magnetic sensor is a Wiegand sensor.

34. The coating device according to claim 21, wherein
a) at least one of the first magnetic sensor and the second magnetic sensor generates electrical energy during operation,
b) an energy storage device is provided for storing the electrical energy generated by at least one of the first magnetic sensor and the second magnetic sensor, and
c) the energy storage device supplies an electrical load with the electrical energy required to operate the load.

35. The coating device according to claim 34, wherein
a) the load comprises an electronic circuit, and
b) the electronic circuit is connected to at least one of the first electro-optical transducer and the second electro-optical transducer in order to transmit information to the electrically grounded area via the optical waveguide.

36. The coating device according to claim 35, wherein the transmitted information is the operating time of the coating device.

37. The coating device according to claim 35, wherein the transmitted information include product identification data for identifying the coating device.

38. The coating device according to claim 17, wherein
a) the coating device comprises an atomizer,
b) the atomizer is arranged in the high-voltage area,
c) at least one of the first magnetic sensor and the second magnetic sensor is arranged in the atomizer, in particular directly on a turbine in the atomizer,
d) at least one of the first electro-optical transducer and the second electro-optical transducer is arranged in the atomizer,
e) the optical waveguide runs outside the atomizer, and
f) at least one of the first magnetic sensor and the second magnetic sensor is connected to at least one of the first electro-optical transducer and the second electro-optical transducer by means of an electrical line in order to permit flexible line routing inside the atomizer.

39. The coating device according to claim 17, wherein
a) the coating device comprises a rotary atomizer,
b) the rotary atomizer is arranged in the high-voltage area,
c) the rotary atomizer comprises a mounting flange for mounting the rotary atomizer on a coating robot,
d) the rotary atomizer includes a turbine for driving the rotary atomizer,
e) the rotary atomizer includes a receiving tube extending from the mounting flange to the turbine, preferably substantially axially, and
f) the mounting tube contains the first magnetic sensor and the first electro-optical transducer.
